(19) United States
(12) Patent Application Publication
(10) Pub. No.: US 2026/0019102 A1
(43) Pub. Date: Jan. 15, 2026

(54) COMMUNICATION COMPONENT

(71) Applicant: OptoMedia Technology Inc., Hsinchu County (TW)

(72) Inventors: Hui-Tsuo CHOU, Hsinchu County (TW); Ming-Hsiang HUANG, Hsinchu County (TW); You-Jen CHEN, Hsinchu County (TW)

(21) Appl. No.: 19/260,300

(22) Filed: Jul. 4, 2025

Related U.S. Application Data
(60) Provisional application No. 63/669,229, filed on Jul. 9, 2024.

(30) Foreign Application Priority Data
Jun. 18, 2025 (TW) 114122850

(51) Int. Cl. H04B 1/76; H04B 1/40; H04L 25/03

(52) U.S. Cl. CPC H04B 1/76; H04B 1/40; H04L 25/03949

(57) ABSTRACT

A communication component includes a conductive part and a controlling module. The conductive part includes a metal main body, a first lower ground pin, a first upper ground pin, a second lower ground pin, and a second upper ground pin. The first upper ground pin is located over the first lower ground pin. The second upper ground pin is located over the second lower ground pin. The controlling module includes a circuit board, a first ground pad, a second ground pad, and a plurality of terminal contact pads. The circuit board contacts the first lower ground pin, the first upper ground pin, the second lower ground pin, and the second upper ground pin. The first ground pad contacts the first lower ground pin and the first upper ground pin. The second ground pad contacts the second lower ground pin and the second upper ground pin.

### CROSS-REFERENCE TO RELATED APPLICATION

This application claims priority to U.S. Provisional Application Ser. No. 63/669,229 filed Jul. 9, 2024, and Taiwan Application Serial Number 114122850, filed Jun. 18, 2025, the disclosures of which are incorporated herein by reference in their entireties.

### BACKGROUND

### Field of Invention

The present disclosure relates to a communication component.

### Description of Related Art

In modern coaxial communication systems, how to achieve structural stability of the overall communication component is one of the most critical concerns in the related field. In addition, minimizing the overall size of the SFP module is also one of the major research directions emphasized by researchers. However, existing communication components fail to effectively overcome issues such as the detachment of high-speed signal terminals of cables caused by external impact. Moreover, if a user intends to monitor the signal status of the SFP module, additional cables and monitoring devices must currently be installed. This significantly increases the overall system size and production cost.

Therefore, how to propose a communication component that can solve the aforementioned problems is one of the problems that the industry is currently eager to invest in research and development resources to solve.

### SUMMARY

In view of this, one purpose of the present disclosure is to provide a communication component that can solve the aforementioned problems.

In order to achieve the above objective, according to an embodiment of the present disclosure, a communication component includes a conductive part and a controlling module. The conductive part includes a metal main body, a first lower ground pin, a first upper ground pin, a second lower ground pin, and a second upper ground pin. The first lower ground pin is disposed on the metal main body. The first upper ground pin is disposed on the metal main body and located over the first lower ground pin. The second lower ground pin is disposed on the metal main body and located at a side of the first lower ground pin. The second upper ground pin is disposed on the metal main body and located over the second lower ground pin. The controlling module is connected to the conductive part. The controlling module includes a circuit board, a first ground pad, a second ground pad, and a plurality of terminal contact pads. The circuit board contacts the first lower ground pin, the first upper ground pin, the second lower ground pin, and the second upper ground pin. The first ground pad and the second ground pad are disposed at two sides of the circuit board. The first ground pad contacts the first lower ground pin and the first upper ground pin. The second ground pad contacts the second lower ground pin and the second upper ground pin. The terminal contact pads are disposed on the circuit board and located between the first ground pad and the second ground pad.

In one or more embodiments of the present disclosure, the first lower ground pin, the first upper ground pin, the second lower ground pin, and the second upper ground pin jointly clamp the circuit board.

In one or more embodiments of the present disclosure, the communication component further includes a plurality of cables electrically connected to the terminal contact pads individually.

In one or more embodiments of the present disclosure, each of the cables includes a signal terminal and a connector. The signal terminal is located at an end of each of the cables and contacts one of the terminal contact pads. The connector is disposed at the other end of each of the cables.

In one or more embodiments of the present disclosure, the conductive part further includes a middle ground pin disposed on the metal main body, the first upper ground pin, the second upper ground pin, and the signal terminal contact an upper surface of the circuit board. The first lower ground pin, the second lower ground pin, and the middle ground pin contact a lower surface of the circuit board.

In one or more embodiments of the present disclosure, the conductive part further has a plurality of terminal holes running through the metal main body, and the cables pass through the terminal holes.

In one or more embodiments of the present disclosure, the terminal holes are located between the first upper ground pin and the second upper ground pin.

In one or more embodiments of the present disclosure, the conductive part further includes a middle ground pin disposed on the metal main body. The middle ground pin is located between the first lower ground pin and the second lower ground pin.

In one or more embodiments of the present disclosure, the middle ground pin, the first lower ground pin, the first upper ground pin, the second lower ground pin, and the second upper ground pin protrude from a side surface of the conductive part.

In one or more embodiments of the present disclosure, the first ground pad, the second ground pad, and the terminal contact pads are located on a first end portion of the circuit board.

In order to achieve the above objective, according to an embodiment of the present disclosure, a communication component includes a conductive part, a controlling module, and a plurality of cables. The conductive part includes a metal main body, a first lower ground pin, a first upper ground pin, a second lower ground pin, and a second upper ground pin. The first lower ground pin and the first upper ground pin are connected to the metal main body and protrude from a side surface of the conductive part. The first upper ground pin is located over the first lower ground pin. The second lower ground pin and the second upper ground pin are connected to the metal main body and protrude from the side surface of the conductive part. The second upper ground pin is located over the second lower ground pin. The controlling module is connected to the conductive part. The controlling module includes a circuit board, a first ground pad, a second ground pad, a plurality of terminal contact pads, a first chip, and a second chip. The circuit board contacts the first lower ground pin, the first upper ground pin, the second lower ground pin, and the second upper ground pin. The first ground pad and the second ground pad are disposed at two sides of the circuit board. The first ground pad contacts the first lower ground pin and the first upper ground pin. The second ground pad contacts the second lower ground pin and the second upper ground pin. The plurality of terminal contact pads are disposed on the circuit board and located between the first ground pad and the second ground pad. The first chip and the second chip are electrically connected to the terminal contact pads. The plurality of cables are electrically connected to the terminal contact pads individually.

In one or more embodiments of the present disclosure, the cables and the controlling module are located on opposite sides of the conductive part.

In one or more embodiments of the present disclosure, the cables include a plurality of signal terminals respectively contacting the terminal contact pads individually.

In one or more embodiments of the present disclosure, the controlling module further includes a processing unit connected to the first chip and the second chip. The processing unit is configured to perform at least one of: adjusting an output signal of the first chip and the second chip; turning off the first chip and the second chip when no input signal is received by the first chip and the second chip; and constantly turning on the first chip and the second chip when the input signal is received by the first chip and the second chip.

In one or more embodiments of the present disclosure, the first chip and the second chip are cable driver chips. The processing unit is configured to: control the first chip and the second chip to receive a transmitter input signal; control the first chip and the second chip to generate a transmitter output signal to one of the cables based on the transmitter input signal; and control the first chip and the second chip to generate a transmitter loop signal to another one of the cables based on the transmitter output signal, and the transmitter loop signal being identical to the transmitter output signal.

In one or more embodiments of the present disclosure, the cables include a first cable, a second cable, a third cable, and a fourth cable. The first cable transmits the transmitter output signal from the first chip. The second cable transmits the transmitter loop signal from the first chip. The third cable transmits the transmitter output signal from the second chip. The fourth cable transmits the transmitter loop signal from the second chip.

In one or more embodiments of the present disclosure, the first chip and the second chip are equalizer chips. The processing unit is configured to: control the first chip and the second chip to receive a receiver input signal from one of the cables; control the first chip and the second chip to generate a receiver output signal based on the receiver input signal; and control the first chip and the second chip to generate a receiver loop signal to another one of the cables based on the receiver input signal, and the receiver loop signal being identical to the receiver output signal.

In one or more embodiments of the present disclosure, the cables comprise a first cable, a second cable, a third cable, and a fourth cable. The first cable transmits the receiver input signal to the first chip. The second cable transmits the receiver loop signal from the first chip. The third cable transmits the receiver input signal to the second chip. The fourth cable transmits the receiver loop signal from the second chip.

In one or more embodiments of the present disclosure, the first chip is a cable driver chip and the second chip is an equalizer chip. The processing unit is configured to: control the first chip to receive a transmitter input signal; control the first chip to generate a transmitter output signal based on the transmitter input signal; control the first chip to generate a transmitter loop signal based on the transmitter output signal, and the transmitter loop signal being identical to the transmitter output signal; control the second chip to receive a receiver input signal; control the second chip to generate a receiver output signal based on the receiver input signal; and control the second chip to generate a receiver loop signal based on the receiver input signal, and the receiver loop signal being identical to the receiver output signal.

In one or more embodiments of the present disclosure, the cables comprise a first cable, a second cable, a third cable, and a fourth cable. The first cable transmits the transmitter output signal from the first chip. The second cable transmits the transmitter loop signal from the first chip. The third cable transmits the receiver input signal to the second chip. The fourth cable transmits the receiver loop signal from the second chip.

In summary, in the communication component of the present disclosure, since the first ground pad and the second ground pad are disposed at two sides of the circuit board and the terminal contact pads are located between the first ground pad and the second ground pad, when the first ground pad contacts the first lower ground pin and the first upper ground pin and the second ground pad contacts the second lower ground pin and the second upper ground pin, the first lower ground pin, the first upper ground pin, the second lower ground pin, and the second upper ground pin can jointly clamp the circuit board, so as to reduce stress caused by external collision and provide sufficient support to the controlling module, thereby preventing the signal terminals of the cables from being detached from the circuit board. In the communication component of the present disclosure, since the first lower ground pin, the first upper ground pin, the second lower ground pin, and the second upper ground pin are located at corners of the circuit board, the conductive (terminal) contact pads can be concentrated at the center of an end of the circuit board, thereby increasing the conductive area on the circuit board. In the communication component of the present disclosure, since the cable driver chip is capable of generating a loop signal identical to the output signal and the equalizer chip is capable of generating a loop signal in a direction opposite to that of the input signal transmission, the loop signal can be used to monitor the output signal without requiring additional cables and monitoring equipment, thereby reducing the occupied space of the entire system. Overall, the communication component of the present disclosure not only enhances the structural stability of the entire assembly but also effectively reduces the overall volume of the communication component.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a communication component in accordance with an embodiment of the present disclosure;

FIG. 2 is an exploded view of the communication component in accordance with an embodiment of the present disclosure;

FIG. 3 is an exploded view of a conductive part, a first cable, a second cable, a third cable, and a fourth cable in accordance with an embodiment of the present disclosure;

FIG. 4 is an exploded view of the conductive part, the first cable, the second cable, the third cable, the fourth cable, and a controlling module in accordance with an embodiment of the present disclosure;

FIG. 5 is a perspective view of the conductive part and the controlling module in accordance with an embodiment of the present disclosure;

FIG. 6 is a cross-sectional view of the communication component in accordance with an embodiment of the present disclosure;

FIG. 7 is a functional block diagram of a communication system in accordance with an embodiment of the present disclosure;

FIG. 8 is a functional block diagram of the communication system in accordance with an embodiment of the present disclosure; and

FIG. 9 is a functional block diagram of the communication system in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit the present disclosure. In other words, in some embodiments of the present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a communication component 100 of this embodiment and the connection relationship between the components will be described in detail.

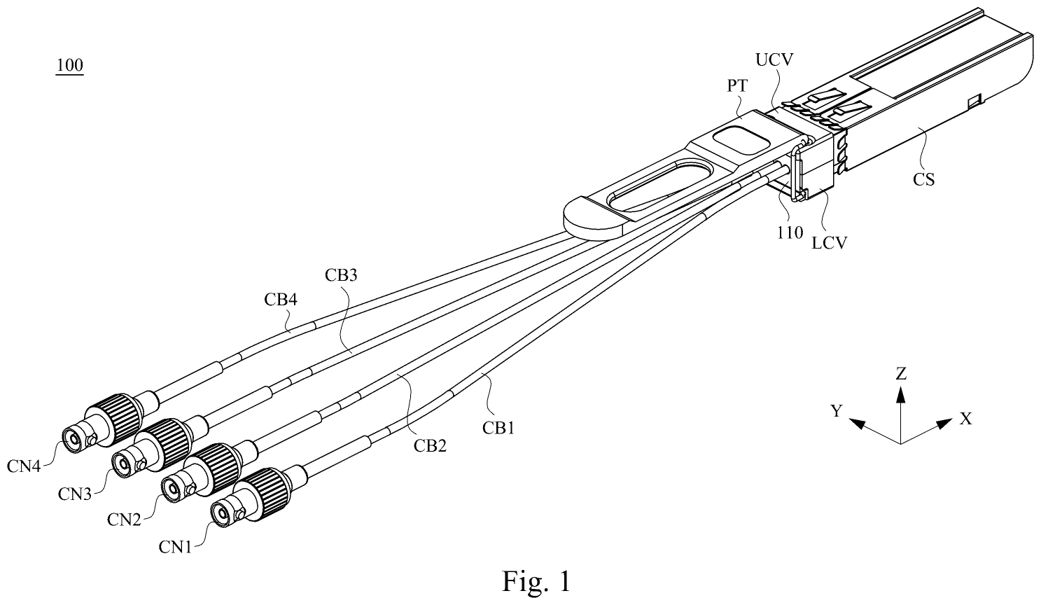

Reference is made to FIG. 1. FIG. 1 illustrates a perspective view of a communication component 100 in accordance with an embodiment of the present disclosure. As shown in FIG. 1, in this embodiment, the communication component 100 includes a conductive part 110, a first cable CB1, a second cable CB2, a third cable CB3, a fourth cable CB4, an upper cover UCV, a lower cover LCV, a housing CS, and a pull tab PT. The first cable CB1, the second cable CB2, the third cable CB3, and the fourth cable CB4 are connected to the conductive part 110. Specifically, an end of each of the first cable CB1, the second cable CB2, the third cable CB3, and the fourth cable CB4 is connected to the conductive part 110. The first cable CB1, the second cable CB2, the third cable CB3, and the fourth cable CB4 respectively include a first connector CN1, a second connector CN2, a third connector CN3, and a fourth connector CN4. The first connector CN1, the second connector CN2, the third connector CN3, and the fourth connector CN4 are respectively located at an end of each of the first cable CB1, the second cable CB2, the third cable CB3, and the fourth cable CB4 away from the conductive part 110. The upper cover UCV and the lower cover LCV cover the conductive part 110. The housing CS wraps the upper cover UCV and the lower cover LCV. Specifically, the housing CS wraps a portion of the upper cover UCV and a portion of the lower cover LCV. The pull tab PT is located on the upper cover UCV.

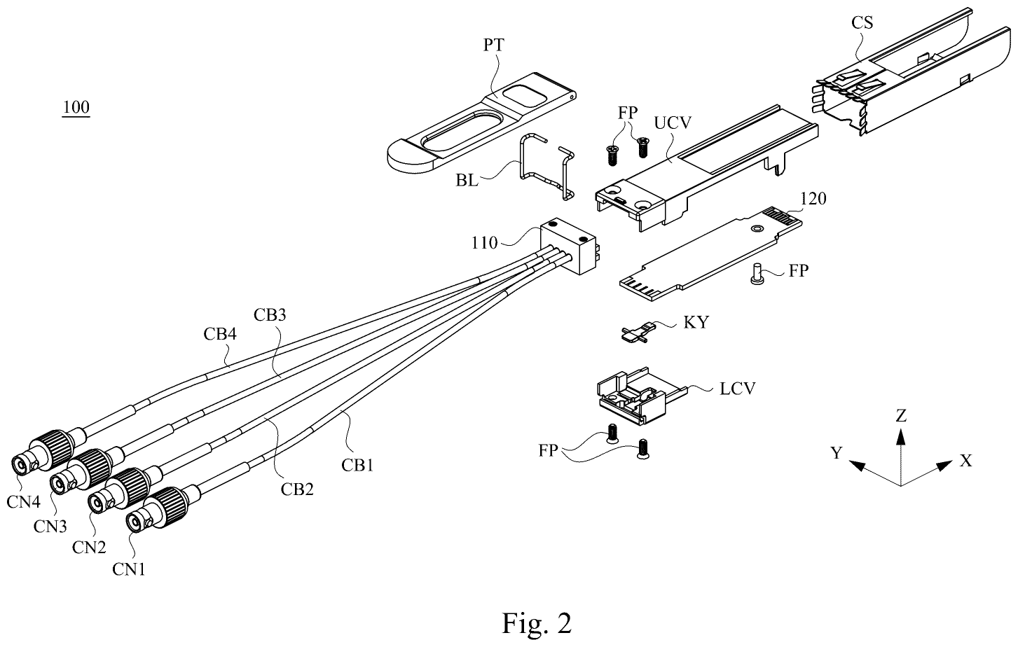

Reference is made to FIG. 2. FIG. 2 is an exploded view of the communication component 100 in accordance with an embodiment of the present disclosure. As shown in FIG. 2, in this embodiment, the communication component 100 further includes a bail BL, a latch key KY, and a plurality of fixing parts FP. The bail BL surrounds an end of the upper cover UCV and the lower cover LCV. Two ends of the bail BL are adjacent to an upper surface of the upper cover UCV. The two ends of the bail BL are pivotally connected to an end of the pull tab PT. The latch key KY is disposed on the lower cover LCV. Two ends of the latch key KY seesaw relative to the lower cover LCV. Specifically, a pivot axis of the latch key KY extends parallel to a direction (e.g., the Y-direction), and the two ends of the latch key KY are arranged along a direction (e.g., the X-direction). An end of the latch key KY is connected to the bail BL, whereas the other end of the latch key KY is engaged with an SFP Cage. In a usage scenario, when a user swings the pull tab PT, the bail BL is lifted generally along a direction (e.g., the Z-direction) and drives the two ends of the latch key KY to seesaw relative to the lower cover LCV, thereby disengaging the other end of the latch key KY from the SFP Cage. Accordingly, the conductive part 110, the first cable CB1, the second cable CB2, the third cable CB3, and the fourth cable CB4 can be detached from the SFP Cage along a direction (e.g., the X-direction).

Reference is made again to FIG. 2. As shown in FIG. 2, in this embodiment, the communication component 100 further includes a controlling module 120. The plurality of fixing parts FP are configured to fix the upper cover UCV and the lower cover LCV to the conductive part 110. The fixing parts FP are further configured to fix the controlling module 120 and the upper cover UCV to each other. In some embodiments, the controlling module 120 is separated from the upper cover UCV by a distance. In other words, the controlling module 120 is not flush against the upper cover UCV. In some embodiments, the controlling module 120 is elongated generally along a direction (e.g., the X-direction).

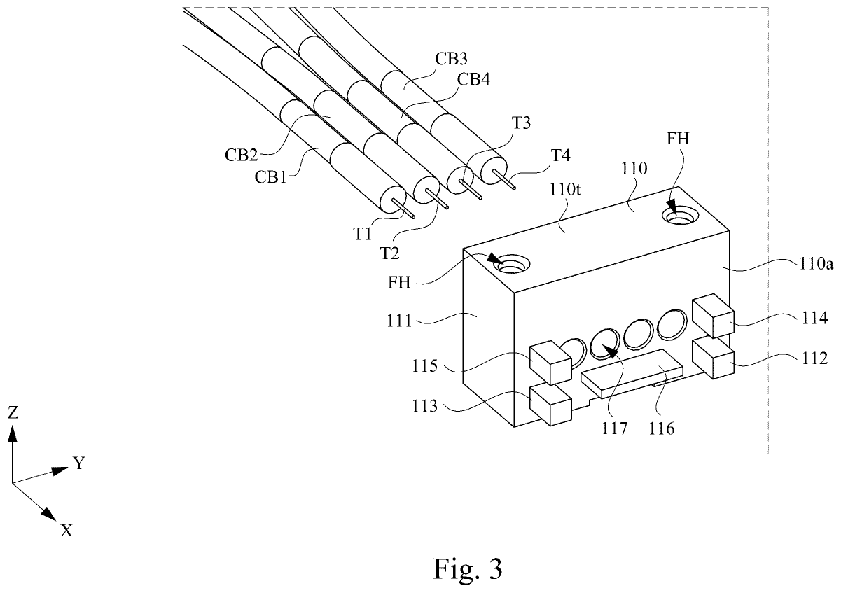

Reference is made to FIG. 3. FIG. 3 is an exploded view of a conductive part 110, a first cable CB1, a second cable CB2, a third cable CB3, and a fourth cable CB4 in accordance with an embodiment of the present disclosure. As shown in FIG. 3, in this embodiment, the first cable CB1, the second cable CB2, the third cable CB3, and the fourth cable CB4 respectively include a first signal terminal T1, a second signal terminal T2, a third signal terminal T3, and a fourth signal terminal T4. The first signal terminal T1, the second signal terminal T2, the third signal terminal T3, and the fourth signal terminal T4 are respectively located at an end of the first cable CB1, the second cable CB2, the third cable CB3, and the fourth cable CB4 close to the conductive part 110. The conductive part 110 includes a metal main body 111, a first lower ground pin 112, a second lower ground pin 113, a first upper ground pin 114, a second upper ground pin 115, and a middle ground pin 116. The first lower ground pin 112, the second lower ground pin 113, the first upper ground pin 114, the second upper ground pin 115, and the middle ground pin 116 are disposed on the metal main body 111. Specifically, the first lower ground pin 112, the second lower ground pin 113, the first upper ground pin 114, the second upper ground pin 115, and the middle ground pin 116 are connected to the metal main body 111 and are disposed on a side surface 110a of the conductive part 110. In some embodiments, the first lower ground pin 112, the second lower ground pin 113, the first upper ground pin 114, the second upper ground pin 115, and the middle ground pin 116 protrude from the side surface 110a of the conductive part 110. The first upper ground pin 114 is located over the first lower ground pin 112. The second lower ground pin 113 is located at a side of the first lower ground pin 112. In some embodiments, a height of the second lower ground pin 113 along a direction (e.g., the Z-direction) is identical to a height of the first lower ground pin 112 along the direction (e.g., the Z-direction). The second upper ground pin 115 is located over the second lower ground pin 113. The middle ground pin 116 is located between the first lower ground pin 112 and the second lower ground pin 113.

Reference is made again to FIG. 3. As shown in FIG. 3, in this embodiment, the conductive part 110 further has a top surface 110t, a plurality of fixing holes FH, and a plurality of terminal holes 117. The fixing holes FH are at least located on the top surface 110t. In some embodiments, the fixing holes FH are also located on a bottom surface (not shown) of the conductive part 110. As shown in FIG. 2 and FIG. 3, the upper cover UCV and the lower cover LCV are fastened to the conductive part 110 by screwing the fixing parts FP into the fixing holes FH. The terminal holes 117 run through the metal main body 111. The first cable CB1, the second cable CB2, the third cable CB3, and the fourth cable CB4 pass through the terminal holes 117. The terminal holes 117 are located between the first upper ground pin 114 and the second upper ground pin 115.

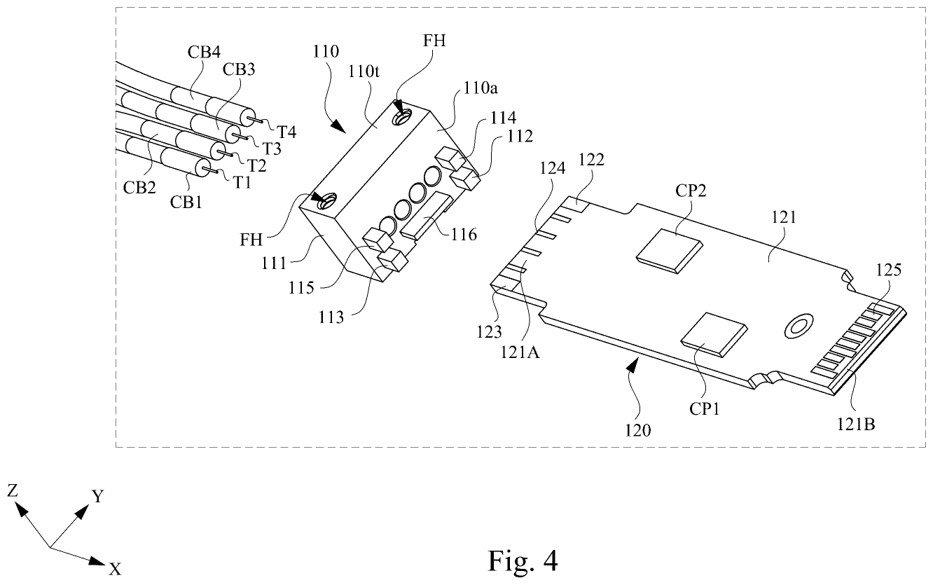

Reference is made to FIG. 4. FIG. 4 is an exploded view of the conductive part 110, the first cable CB1, the second cable CB2, the third cable CB3, the fourth cable CB4, and a controlling module 120 in accordance with an embodiment of the present disclosure. As shown in FIG. 4, in this embodiment, the controlling module 120 is configured to be connected to the conductive part 110. The controlling module 120 includes a circuit board 121, a first ground pad 122, a second ground pad 123, a plurality of terminal contact pads 124, and a plurality of gold fingers 125. Specifically, the circuit board 121 has a first end portion 121A and a second end portion 121B. The first end portion 121A is located at an end of the circuit board 121 close to the conductive part 110, and the second end portion 121B is located at an end of the circuit board 121 away from the conductive part 110. The first ground pad 122, the second ground pad 123, and the terminal contact pads 124 are located on the first end portion 121A of the circuit board 121. The plurality of gold fingers 125 are located at the second end portion 121B of the circuit board 121. The circuit board 121 contacts the first lower ground pin 112, the first upper ground pin 114, the second lower ground pin 113, and the second upper ground pin 115. The first ground pad 122 and the second ground pad 123 are disposed at two sides of the circuit board 121. Specifically, the first ground pad 122 and the second ground pad 123 are located at two sides of the first end portion 121A. The plurality of terminal contact pads 124 are located between the first ground pad 122 and the second ground pad 123. The controlling module 120 further includes a first chip CP1 and a second chip CP2 disposed on the circuit board 121. The first chip CP1 and the second chip CP2 are electrically connected to the terminal contact pads 124.

In some embodiments, the first ground pad 122, the second ground pad 123, and the terminal contact pads 124 are arranged on the first end portion 121A of the circuit board 121 along a direction (e.g., the Y-direction). In some embodiments, the plurality of gold fingers 125 are arranged on the second end portion 121B of the circuit board 121 along a direction (e.g., the Y-direction).

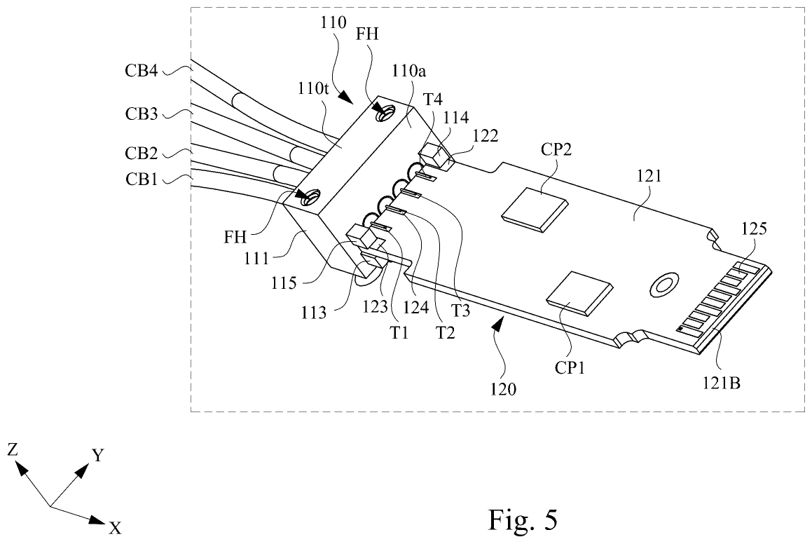

Reference is made to FIG. 5. FIG. 5 is a perspective view of the conductive part 110 and the controlling module 120 in accordance with an embodiment of the present disclosure. As shown in FIG. 5, in this embodiment, the first cable CB1, the second cable CB2, the third cable CB3, and the fourth cable CB4 are located on a side of the conductive part 110, whereas the controlling module 120 is located on the other side of the conductive part 110. In other words, the composite of the first cable CB1, the second cable CB2, the third cable CB3, and the fourth cable CB4 and the controlling module 120 are located on opposite sides of the conductive part 110. As shown in FIG. 4 and FIG. 5, the first ground pad 122 contacts the first lower ground pin 112 and the first upper ground pin 114, and the second ground pad 123 contacts the second lower ground pin 113 and the second upper ground pin 115. The first signal terminal T1 of the first cable CB1, the second signal terminal T2 of the second cable CB2, the third signal terminal T3 of the third cable CB3, and the fourth signal terminal T4 of the fourth cable CB4 contact the terminal contact pads 124. Accordingly, the first signal terminal T1 of the first cable CB1, the second signal terminal T2 of the second cable CB2, the third signal terminal T3 of the third cable CB3, and the fourth signal terminal T4 of the fourth cable CB4 are electrically connected to the terminal contact pads 124.

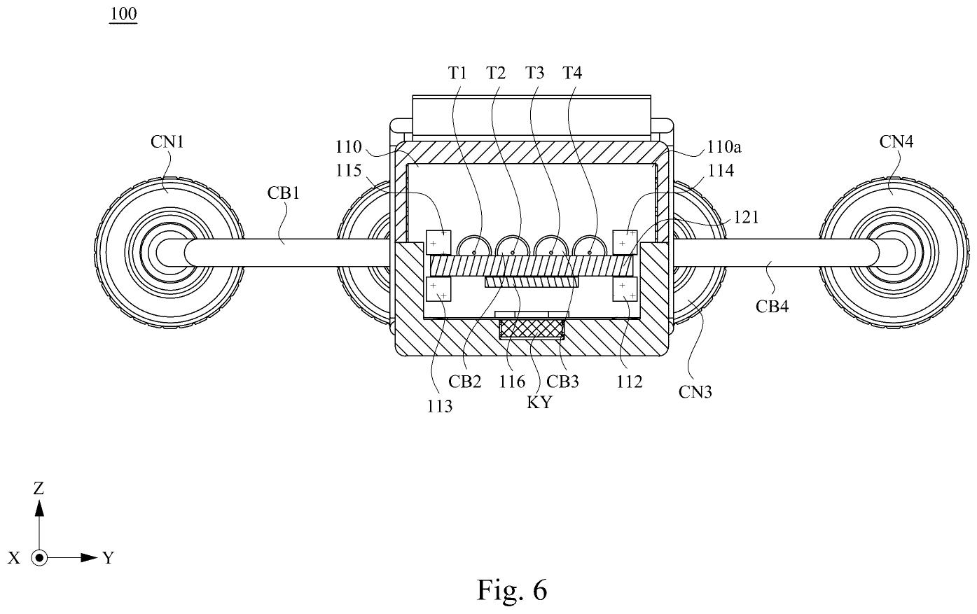

Reference is made to FIG. 6. FIG. 6 is a cross-sectional view of the communication component 100 in accordance with an embodiment of the present disclosure. As shown in FIG. 6, in this embodiment, the first lower ground pin 112, the first upper ground pin 114, the second lower ground pin 113, and the second upper ground pin 115 jointly clamp the circuit board 121 of the controlling module 120. In detail, the first lower ground pin 112, the first upper ground pin 114, the second lower ground pin 113, and the second upper ground pin 115 clamp portions of the circuit board 121 located at its corners, and the middle ground pin 116 supports a middle portion of the circuit board 121. In some embodiments, the first upper ground pin 114, the second upper ground pin 115, the first signal terminal T1, the second signal terminal T2, the third signal terminal T3, and the fourth signal terminal T4 contact an upper surface of the circuit board 121, and the first lower ground pin 112, the second lower ground pin 113, and the middle ground pin 116 contact a lower surface of the circuit board 121. This ensures that the overall structure of the communication component 100 is stable and not easily disassembled, thereby preventing failures or damages.

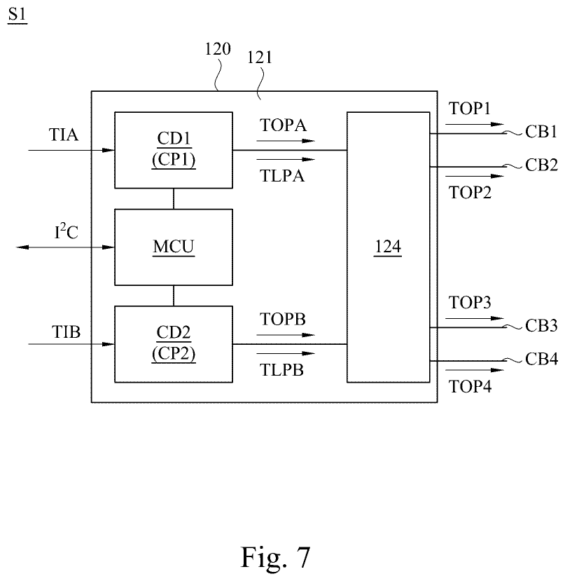

Reference is made to FIG. 7. FIG. 7 is a functional block diagram of a communication system S1 in accordance with an embodiment of the present disclosure. As shown in FIG. 7, in this embodiment, the communication system S1 includes the circuit board 121, the terminal contact pads 124, a first chip CP1, a second chip CP2, and a processing unit MCU. The processing unit MCU is disposed on the circuit board 121 and is connected to the first chip CP1 and the second chip CP2. In the communication system S1, the first chip CP1 and the second chip CP2 are respectively a cable driver chip CD1 and a cable driver chip CD2. The cable driver chip CD1 and the cable driver chip CD2 are configured to receive input signals from a coaxial transmitter module (not shown) and generate output signals and loop signals based on the input signals. The processing unit MCU is configured to adjust the output signals of the cable driver chip CD1 and the cable driver chip CD2. Specifically, the processing unit MCU may adjust the intensity of the output signals from the cable driver chip CD1 and the cable driver chip CD2 to be greater or less than the intensity of the input signals. In some embodiments, the processing unit MCU is configured to turn off the cable driver chip CD1 and the cable driver chip CD2 when no input signal is received by the cable driver chip CD1 and the cable driver chip CD2. Specifically, when the processing unit MCU detects that no input signal is transmitted to the cable driver chip CD1 and the cable driver chip CD2, the processing unit MCU can automatically power off the cable driver chip CD1 and the cable driver chip CD2 to conserve energy. In some embodiments, the processing unit MCU is configured to constantly turn on the cable driver chip CD1 and the cable driver chip CD2 when the input signal is received by the cable driver chip CD1 and the cable driver chip CD2. Specifically, the processing unit MCU can maintain the cable driver chip CD1 and the cable driver chip CD2 in an operating state, so that upon receiving the input signals, the cable driver chip CD1 and the cable driver chip CD2 can promptly process the input signals and generate the corresponding output signals and loop signals.

Reference is again made to FIG. 7. As shown in FIG. 7, in this embodiment, the processing unit MCU is configured to control the first chip CP1 and the second chip CP2 to receive the input signals. Specifically, the processing unit MCU controls the cable driver chip CD1 and the cable driver chip CD2 to respectively receive a transmitter input signal TIA and a transmitter input signal TIB. Next, the processing unit MCU is configured to control the first chip CP1 and the second chip CP2 to generate output signals based on the input signals. Specifically, the processing unit MCU controls the cable driver chip CD1 and the cable driver chip CD2 to generate a transmitter output signal TOPA and a transmitter output signal TOPB based on the transmitter input signal TIA and the transmitter input signal TIB, respectively. Next, the processing unit MCU is configured to control the first chip CP1 and the second chip CP2 to generate loop signals based on the output signals. Specifically, the processing unit MCU controls the cable driver chip CD1 and the cable driver chip CD2 to generate a transmitter loop signal TLPA and a transmitter loop signal TLPB based on the transmitter output signal TOPA and the transmitter output signal TOPB, respectively. The transmitter loop signal TLPA is identical to the transmitter output signal TOPA, and the transmitter loop signal TLPB is identical to the transmitter output signal TOPB.

Reference is again made to FIG. 7. The transmitter output signal TOPA is transmitted through the terminal contact pad 124 to the first cable CB1, so that the first cable CB1 transmits a transmitter output signal TOP1 identical to the transmitter output signal TOPA. The transmitter loop signal TLPA is transmitted through the terminal contact pad 124 to the second cable CB2, so that the second cable CB2 transmits a transmitter output signal TOP2 identical to the transmitter loop signal TLPA. The transmitter output signal TOPB is transmitted through the terminal contact pad 124 to the third cable CB3, so that the third cable CB3 transmits a transmitter output signal TOP3 identical to the transmitter output signal TOPB. The transmitter loop signal TLPB is transmitted through the terminal contact pad 124 to the fourth cable CB4, so that the fourth cable CB4 transmits a transmitter output signal TOP4 identical to the transmitter loop signal TLPB.

In a usage scenario, by the structural configuration of the communication system S1, a user may monitor the output signals of the first cable CB1 and the third cable CB3, based on the input signals from the coaxial transmitter module, merely through the second cable CB2 and the fourth cable CB4 of the communication component 100, without installing additional cables or monitoring equipment.

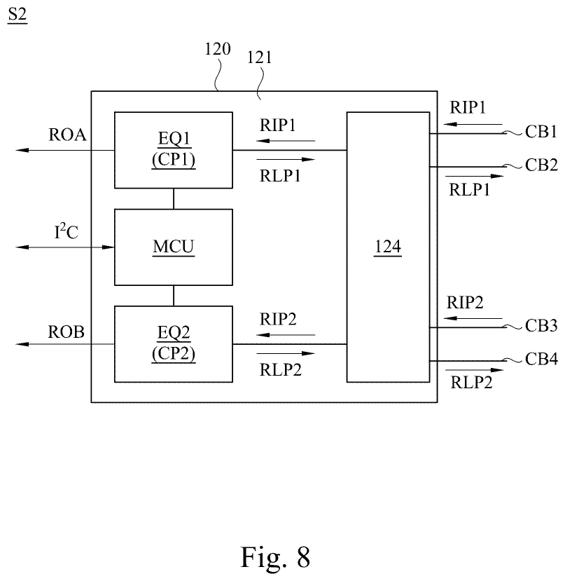

Reference is made to FIG. 8. FIG. 8 is a functional block diagram of the communication system S2 in accordance with an embodiment of the present disclosure. As shown in FIG. 8, in this embodiment, the communication system S2 includes the circuit board 121, the terminal contact pads 124, the first chip CP1, the second chip CP2, and the processing unit MCU. In the communication system S2, the first chip CP1 and the second chip CP2 are respectively an equalizer chip EQ1 and an equalizer chip EQ2. The equalizer chip EQ1 and the equalizer chip EQ2 are configured to receive input signals from a coaxial receiver module (not shown) and to generate output signals and loop signals based on the input signals. The processing unit MCU is configured to adjust the output signals of the equalizer chip EQ1 and the equalizer chip EQ2. Specifically, the processing unit MCU may adjust the intensity of the output signals from the equalizer chip EQ1 and the equalizer chip EQ2 to be greater or less than the intensity of the input signals. In some embodiments, the processing unit MCU is configured to turn off the equalizer chip EQ1 and the equalizer chip EQ2 when no input signal is received by the equalizer chip EQ1 and the equalizer chip EQ2. Specifically, when the processing unit MCU detects that no input signal is transmitted to the equalizer chip EQ1 and the equalizer chip EQ2, the processing unit MCU can automatically power off the equalizer chip EQ1 and the equalizer chip EQ2 to conserve energy. In some embodiments, the processing unit MCU is configured to constantly turn on the equalizer chip EQ1 and the equalizer chip EQ2 when the input signal is received by the equalizer chip EQ1 and the equalizer chip EQ2. Specifically, the processing unit MCU can maintain the equalizer chip EQ1 and the equalizer chip EQ2 in an operating state, so that upon receiving the input signals, the equalizer chip EQ1 and the equalizer chip EQ2 can promptly process the input signals and generate the corresponding output signals and loop signals.

Reference is again made to FIG. 8. As shown in FIG. 8, in this embodiment, the processing unit MCU is configured to control the first chip CP1 and the second chip CP2 to receive the input signals. Specifically, the processing unit MCU controls the equalizer chip EQ1 and the equalizer chip EQ2 to receive a receiver input signal RIP1 and a receiver input signal RIP2, respectively. More specifically, the first cable CB1 and the third cable CB3 respectively transmit the receiver input signal RIP1 and the receiver input signal RIP2, and the processing unit MCU controls the equalizer chip EQ1 and the equalizer chip EQ2 to respectively receive the receiver input signal RIP1 and the receiver input signal RIP2 from the first cable CB1 and the third cable CB3. Next, the processing unit MCU is configured to control the first chip CP1 and the second chip CP2 to generate output signals based on the input signals. Specifically, the processing unit MCU controls the equalizer chip EQ1 and the equalizer chip EQ2 to generate a receiver output signal ROA and a receiver output signal ROB based on the receiver input signal RIP1 and the receiver input signal RIP2, respectively. Next, the processing unit MCU is configured to control the first chip CP1 and the second chip CP2 to generate loop signals based on the output signals. Specifically, the processing unit MCU controls the equalizer chip EQ1 and the equalizer chip EQ2 to generate a receiver loop signal RLP1 and a receiver loop signal RLP2 based on the receiver output signal ROA and the receiver output signal ROB, respectively. The receiver loop signal RLP1 is identical to the receiver output signal ROA, and the receiver loop signal RLP2 is identical to the receiver output signal ROB.

Reference is again made to FIG. 8. The receiver input signal RIP1 is transmitted from the first cable CB1 through the terminal contact pad 124 to the equalizer chip EQ1, so that the equalizer chip EQ1 generates a receiver output signal ROA identical to the receiver input signal RIP1. The receiver loop signal RLP1 is transmitted through the terminal contact pad 124 to the second cable CB2, so that the second cable CB2 transmits the receiver loop signal RLP1 identical to the receiver output signal ROA. The receiver input signal RIP2 is transmitted from the third cable CB3 through the terminal contact pad 124 to the equalizer chip EQ2, so that the equalizer chip EQ2 generates a receiver output signal ROB identical to the receiver input signal RIP2. The receiver loop signal RLP2 is transmitted through the terminal contact pad 124 to the fourth cable CB4, so that the fourth cable CB4 transmits the receiver loop signal RLP2 identical to the receiver output signal ROB.

In a usage scenario, by the structural configuration of the communication system S2, a user may monitor the output signals of the first cable CB1 and the third cable CB3, based on the input signals from the coaxial receiver module, merely through the second cable CB2 and the fourth cable CB4 of the communication component 100, without installing additional cables or monitoring equipment.

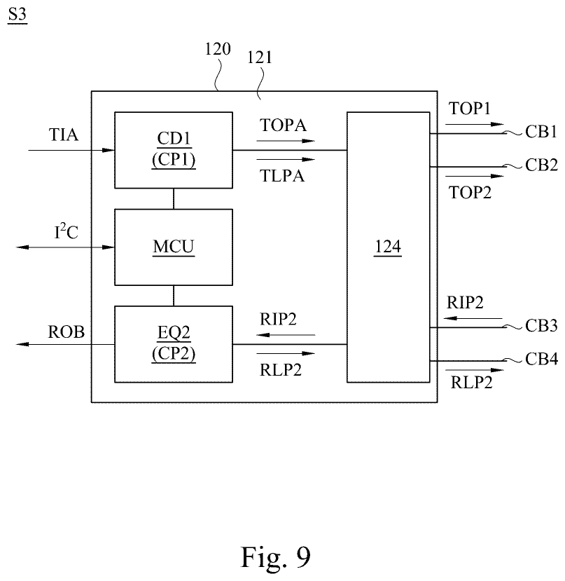

Reference is made to FIG. 9. FIG. 9 is a functional block diagram of the communication system S3 in accordance with an embodiment of the present disclosure. As shown in FIG. 9, in this embodiment, the communication system S3 includes the circuit board 121, the terminal contact pads 124, the first chip CP1, the second chip CP2, and the processing unit MCU. In the communication system S3, the first chip CP1 and the second chip CP2 are respectively the cable driver chip CD1 and the equalizer chip EQ2. The cable driver chip CD1 and the equalizer chip EQ2 are configured to respectively receive input signals from a coaxial transmitter module (not shown) and a coaxial receiver module (not shown), and to generate output signals and loop signals based on the input signals. Since the cable driver chip CD1 in FIG. 9 is identical to the cable driver chip CD1 in FIG. 7, and the equalizer chip EQ2 in FIG. 9 is identical to the equalizer chip EQ2 in FIG. 8, repeated description is omitted herein.

Reference is again made to FIG. 9. As shown in FIG. 9, in this embodiment, the processing unit MCU is configured to control the first chip CP1 and the second chip CP2 to receive the input signals. Specifically, the processing unit MCU controls the cable driver chip CD1 and the equalizer chip EQ2 to respectively receive the transmitter input signal TIA and the receiver input signal RIP2. Next, the processing unit MCU is configured to control the first chip CP1 and the second chip CP2 to generate output signals based on the input signals. Specifically, the processing unit MCU controls the cable driver chip CD1 and the equalizer chip EQ2 to respectively generate the transmitter output signal TOPA and the receiver output signal ROB based on the transmitter input signal TIA and the receiver input signal RIP2. Next, the processing unit MCU is configured to control the first chip CP1 and the second chip CP2 to generate loop signals based on the output signals. Specifically, the processing unit MCU controls the cable driver chip CD1 and the equalizer chip EQ2 to respectively generate the transmitter loop signal TLPA and the receiver loop signal RLP2 based on the transmitter output signal TOPA and the receiver output signal ROB. The transmitter loop signal TLPA is identical to the transmitter output signal TOPA, and the receiver loop signal RLP2 is identical to the receiver output signal ROB.

Reference is again made to FIG. 9. The transmitter output signal TOPA is transmitted through the terminal contact pad 124 to the first cable CB1, so that the first cable CB1 transmits the transmitter output signal TOP1 identical to the transmitter output signal TOPA. The transmitter loop signal TLPA is transmitted through the terminal contact pad 124 to the second cable CB2, so that the second cable CB2 transmits the transmitter output signal TOP2 identical to the transmitter loop signal TLPA. The receiver input signal RIP2 is transmitted from the third cable CB3 through the terminal contact pad 124 to the equalizer chip EQ2, so that the equalizer chip EQ2 generates the receiver output signal ROB identical to the receiver input signal RIP2. The receiver loop signal RLP2 is transmitted through the terminal contact pad 124 to the fourth cable CB4, so that the fourth cable CB4 transmits the receiver loop signal RLP2 identical to the receiver output signal ROB.

In a usage scenario, by the structural configuration of the communication system S3, a user may monitor the output signals of the first cable CB1 and the third cable CB3, based on the input signals from the coaxial transmitter module and the coaxial receiver module, merely through the second cable CB2 and the fourth cable CB4 of the communication component 100, without installing additional cables or monitoring equipment.

In some embodiments, the processing unit MCU may be controlled by another controlling unit (not shown) under the I²C communication protocol. In some embodiments, the communication protocol I²C may adopt the Inter-Integrated Circuit protocol, for example.

In some embodiments, the processing unit MCU may be, for example, a microprocessor or another type of processing unit.

From the above detailed description of the specific embodiments of the present disclosure, it can be clearly seen that in the communication component of the present disclosure, since the first ground pad and the second ground pad are disposed at two sides of the circuit board and the terminal contact pads are located between the first ground pad and the second ground pad, when the first ground pad contacts the first lower ground pin and the first upper ground pin and the second ground pad contacts the second lower ground pin and the second upper ground pin, the first lower ground pin, the first upper ground pin, the second lower ground pin, and the second upper ground pin can jointly clamp the circuit board, so as to reduce stress caused by external collision and provide sufficient support to the controlling module, thereby preventing the signal terminals of the cables from being detached from the circuit board. In the communication component of the present disclosure, since the first lower ground pin, the first upper ground pin, the second lower ground pin, and the second upper ground pin are located at corners of the circuit board, the conductive (terminal) contact pads can be concentrated at the center of an end of the circuit board, thereby increasing the conductive area on the circuit board. In the communication component of the present disclosure, since the cable driver chip is capable of generating a loop signal identical to the output signal and the equalizer chip is capable of generating a loop signal in a direction opposite to that of the input signal transmission, the loop signal can be used to monitor the output signal without requiring additional cables and monitoring equipment, thereby reducing the occupied space of the entire system. Overall, the communication component of the present disclosure not only enhances the structural stability of the entire assembly but also effectively reduces the overall volume of the communication component.

Although the present disclosure has been described with reference to the above embodiments, it is not intended to limit the present disclosure. Various modifications and refinements may be made by those skilled in the art without departing from the spirit and scope of the present disclosure. Therefore, the scope of protection of the present disclosure shall be defined by the appended claims.

What is claimed is:

1. A communication component, comprising:
a conductive part, comprising:
a metal main body;
a first lower ground pin disposed on the metal main body;
a first upper ground pin disposed on the metal main body and located over the first lower ground pin;
a second lower ground pin disposed on the metal main body and located at a side of the first lower ground pin; and
a second upper ground pin disposed on the metal main body and located over the second lower ground pin; and
a controlling module connected to the conductive part, comprising:
a circuit board contacting the first lower ground pin, the first upper ground pin, the second lower ground pin, and the second upper ground pin;
a first ground pad and a second ground pad disposed at two sides of the circuit board, wherein the first ground pad contacts the first lower ground pin and the first upper ground pin, and the second ground pad contacts the second lower ground pin and the second upper ground pin; and
a plurality of terminal contact pads disposed on the circuit board and located between the first ground pad and the second ground pad.

2. The communication component of claim 1, wherein the first lower ground pin, the first upper ground pin, the second lower ground pin, and the second upper ground pin jointly clamp the circuit board.

3. The communication component of claim 1, further comprising a plurality of cables electrically connected to the terminal contact pads individually.

4. The communication component of claim 3, wherein each of the cables comprises:
a signal terminal located at an end of each of the cables and contacting one of the terminal contact pads; and
a connector disposed at the other end of each of the cables.

5. The communication component of claim 4, wherein the conductive part further comprises a middle ground pin disposed on the metal main body, the first upper ground pin, the second upper ground pin, and the signal terminal contact an upper surface of the circuit board, and the first lower ground pin, the second lower ground pin, and the middle ground pin contact a lower surface of the circuit board.

6. The communication component of claim 3, wherein the conductive part further has a plurality of terminal holes running through the metal main body, and the cables pass through the terminal holes.

7. The communication component of claim 6, wherein the terminal holes are located between the first upper ground pin and the second upper ground pin.

8. The communication component of claim 1, wherein the conductive part further comprises a middle ground pin disposed on the metal main body, and the middle ground pin is located between the first lower ground pin and the second lower ground pin.

9. The communication component of claim 8, wherein the middle ground pin, the first lower ground pin, the first upper ground pin, the second lower ground pin, and the second upper ground pin protrude from a side surface of the conductive part.

10. The communication component of claim 1, wherein the first ground pad, the second ground pad, and the terminal contact pads are located on a first end portion of the circuit board.

11. A communication component, comprising:
a conductive part, comprising:
a metal main body;
a first lower ground pin and a first upper ground pin connected to the metal main body and protruding from a side surface of the conductive part, and the first upper ground pin being located over the first lower ground pin; and
a second lower ground pin and a second upper ground pin connected to the metal main body and protruding from the side surface of the conductive part, and the second upper ground pin being located over the second lower ground pin;
a controlling module connected to the conductive part, comprising:
a circuit board contacting the first lower ground pin, the first upper ground pin, the second lower ground pin, and the second upper ground pin;
a first ground pad and a second ground pad disposed at two sides of the circuit board, wherein the first ground pad contacts the first lower ground pin and the first upper ground pin, and the second ground pad contacts the second lower ground pin and the second upper ground pin;
a plurality of terminal contact pads disposed on the circuit board and located between the first ground pad and the second ground pad; and
a first chip and a second chip electrically connected to the terminal contact pads; and
a plurality of cables electrically connected to the terminal contact pads individually.

12. The communication component of claim 11, wherein the cables and the controlling module are located on opposite sides of the conductive part.

13. The communication component of claim 11, wherein the cables comprise a plurality of signal terminals respectively contacting the terminal contact pads individually.

14. The communication component of claim 11, wherein the controlling module further comprises a processing unit connected to the first chip and the second chip, and the processing unit is configured to perform at least one of:
adjusting an output signal of the first chip and the second chip;
turning off the first chip and the second chip when no input signal is received by the first chip and the second chip; and
constantly turning on the first chip and the second chip when the input signal is received by the first chip and the second chip.

15. The communication component of claim 14, wherein the first chip and the second chip are cable driver chips, and the processing unit is configured to:
control the first chip and the second chip to receive a transmitter input signal;
control the first chip and the second chip to generate a transmitter output signal to one of the cables based on the transmitter input signal; and
control the first chip and the second chip to generate a transmitter loop signal to another one of the cables based on the transmitter output signal, and the transmitter loop signal being identical to the transmitter output signal.

16. The communication component of claim 15, wherein the cables comprise a first cable, a second cable, a third cable, and a fourth cable, the first cable transmits the transmitter output signal from the first chip, the second cable transmits the transmitter loop signal from the first chip, the third cable transmits the transmitter output signal from the second chip, and the fourth cable transmits the transmitter loop signal from the second chip.

17. The communication component of claim 14, wherein the first chip and the second chip are equalizer chips, and the processing unit is configured to:
control the first chip and the second chip to receive a receiver input signal from one of the cables;
control the first chip and the second chip to generate a receiver output signal based on the receiver input signal; and
control the first chip and the second chip to generate a receiver loop signal to another one of the cables based on the receiver input signal, and the receiver loop signal being identical to the receiver output signal.

18. The communication component of claim 17, wherein the cables comprise a first cable, a second cable, a third cable, and a fourth cable, the first cable transmits the receiver input signal to the first chip, the second cable transmits the receiver loop signal from the first chip, the third cable transmits the receiver input signal to the second chip, and the fourth cable transmits the receiver loop signal from the second chip.

19. The communication component of claim 14, wherein the first chip is a cable driver chip and the second chip is an equalizer chip, and the processing unit is configured to:
control the first chip to receive a transmitter input signal;
control the first chip to generate a transmitter output signal based on the transmitter input signal;
control the first chip to generate a transmitter loop signal based on the transmitter output signal, and the transmitter loop signal being identical to the transmitter output signal;
control the second chip to receive a receiver input signal;
control the second chip to generate a receiver output signal based on the receiver input signal; and
control the second chip to generate a receiver loop signal based on the receiver input signal, and the receiver loop signal being identical to the receiver output signal.

20. The communication component of claim 19, wherein the cables comprise a first cable, a second cable, a third cable, and a fourth cable, the first cable transmits the transmitter output signal from the first chip, the second cable transmits the transmitter loop signal from the first chip, the third cable transmits the receiver input signal to the second chip, and the fourth cable transmits the receiver loop signal from the second chip.
